(19) United States
(12) Patent Application Publication
(10) Pub. No.: US 2006/0025510 A1
(43) Pub. Date: Feb. 2, 2006

(54) Flame retardant polymer blend and articles thereof

(76) Inventors: David M. Dean, West Chester, PA (US); Richard J. Arhart, Wilmington, DE (US); Robert V. Kasowski, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/910,171

(22) Filed: Aug. 2, 2004

(51) Int. Cl. C08K 3/10; C08K 3/40

(52) U.S. Cl. 524/409; 524/494

(57) ABSTRACT

A flame retardant polyphenylene sulfide polymeric alloy composition based on polyphenylene sulfide, a polymeric grafting agent (e.g., ethylene/n-butyl acrylate/glycidyl methacrylate terpolymer) and an ethylene copolymer (e.g., ethylene/methacrylic acid ionomer) is provided. At about 35% by weight loading with glass fibers and 13% by weight loading of brominated polystyrene (10%) and antimony oxide (3%), the composition is self extinguishing under UL-94 and retains greater than 3% elongation at break according to ASTM D638.

### BACKGROUND OF THE INVENTION

1. Field of the Invention

The present invention relates to flame retardant thermoplastic polymer alloy compositions and to articles comprising the compositions of the invention. More specifically, the invention relates to a blend of polyphenylene sulfide (PPS) with a polymeric grafting agent, an ethylene/acid copolymer, a brominated polystyrene, antimony oxide, and, optionally, flame retardant fibers. The PPS blend of the invention is self extinguishing in the UL-94 test, and retains over 3% elongation at break when measured according to ASTM D638.

2. Description of Related Art

Several patents and publications are cited in this description in order to more fully describe the state of the art to which this invention pertains. The entire disclosure of each of these patents and publications is incorporated by reference herein.

Temperature requirements for various flame resistant articles continue to increase. Thermoplastic polyvinyl chloride (PVC), used in high volume flame retardant applications, provides chemical and flame resistance, insulation capability, and reasonable toughness. PVC, however, suffers from deficiencies in its higher temperature capability, and also from environmental concerns relating to the release of halogen compounds upon combustion. The difficulties in disposing of and recycling PVC resin are also recognized as serious problems. Incinerating PVC, as noted, results in the formation of significant quantities of hydrogen chloride and heavy metal residues. Additionally, PVC is not compatible with other plastics used in the manufacture of various articles, such as automobiles, which may create problems during recycling operations.

Polyphenylene sulfide (PPS) is a high temperature, semicrystalline, engineering thermoplastic with excellent chemical resistance, high heat deflection temperature, good electrical insulation properties, and inherent flame resistance without halogen content. Its poor flexibility can be seen in low impact strength and low elongation at break. Thus, the use of PPS has been limited in applications that require high temperature capability, impact resistance, and flexibility.

U.S. Pat. No. 6,608,136 describes toughened polyphenylene sulfide alloy compositions formed by melt blending certain ethylene copolymers and certain polymeric grafting agents that contain reactive groups selected from at least one of epoxides, isocyanates, aziridine, silanes, alkyl halides, alpha-halo ketones, alpha-halo aldehydes, or oxazoline, with polyphenylene sulfide. These compositions are flexible, tough thermoplastic alloys with low and high temperature capability and good electrical properties, suitable for use in wire and cable applications.

These PPS alloys are not optimized, however, for certain engineering polymer applications that require flame resistance, for example a VO rating, in a material that may include a filler and that requires a high flex modulus and an elongation at break that is greater than 3%.

From the foregoing, it is apparent that there remains a need in the art for a flexible, tough thermoplastic composition with low and high temperature capability and VO-rated flame resistance, for certain engineering polymer applications that may include a filler and that require a material with a high flex modulus and a significant elongation at break.

### SUMMARY OF THE INVENTION

A flexible flame retardant composition is provided. The composition includes
(A) from about 52 to 72 weight percent of a polymer blend consisting essentially of:
   (a) from 40% to 95% by weight polyphenylene sulfide;
   (b) from 3% to 50% by weight of a polymeric grafting agent, said grafting agent comprising a copolymer wherein for every one hundred parts by weight copolymer (i) at least 50 parts by weight are derived from ethylene comonomer; (ii) from 0.5 to 15 parts by weight are derived from one or more reactive comonomer selected from the group consisting of an unsaturated epoxide of 4 to 11 carbon atoms; an unsaturated isocyanate of 2 to 11 carbon atoms; an unsaturated alkoxy silane and unsaturated alkyl silane, wherein the alkoxy and the alkyl group is from 1 to 12 carbon atoms; and an unsaturated oxazoline; and (iii) from 0 to 49 parts by weight are derived from an optional third comonomer selected from the group consisting of an alkyl acrylate, alkyl methacrylate, vinyl ether, carbon monoxide, and sulfur dioxide, where the alkyl and ether groups are of 1 to 12 carbon atoms; and
   (c) from 1% to 20% by weight of an ethylene copolymer, wherein for every one hundred parts by weight ethylene copolymer (i) at least 50 parts by weight are derived from ethylene comonomer, (ii) from 1 to 35 parts by weight are derived from an acid-containing unsaturated carboxylic acid or anhydride comonomer, and (iii) from 0 to 49 parts by weight are derived from a comonomer selected from the group consisting of alkyl acrylate, alkyl methacrylate, vinyl ether, carbon monoxide, and sulfur dioxide, and further wherein the acid groups are neutralized from 0 to 100% by a metal ion,
(B) at least 8 weight percent and up to about 13 weight percent of brominated polystyrene and antimony oxide; and, optionally,
(C) up to about 45 weight percent fiber glass.

Moreover, the flame retardant composition is self extinguishing in 10 seconds or less according to UL-94 and exhibits elongation at break in excess of 3.0% according to ASTM D638.

Also provided is an article comprising the flame retardant composition of the invention.

### DETAILED DESCRIPTION OF THE INVENTION

The following definitions apply to the terms as used throughout this specification, unless otherwise limited in specific instances.

The term “flammable”, as used herein, refers to the property of igniting or burning readily in air.

The term “flame retardant”, as used herein, refers to the property of resisting ignition or combustion in air. Any decrease in the flammability of a material, when compared to a conventional material, is included in the definition of “flame retardant”. For example, halogenated organic polymers are flame retardant, because they ignite or combust less readily than non-halogenated organic polymers. Likewise, organic polymers blended with silicone compounds are flame retardant, because they ignite or combust less readily than neat organic polymers.

In this connection, the limiting oxygen index (LOI) is a measurement of the minimum percentage of oxygen in a flowing mixture of oxygen and nitrogen that will support combustion of a test material. It is apparent that a test material whose LOI is measured to be greater than 21%, that is, the oxygen content of the ambient atmosphere, can be considered to have flame retardant properties.

As used herein, the terms “flame resistant” and “fire resistant” are synonymous with “flame retardant”.

In this disclosure, the word “copolymer” refers to polymers polymerized from two or more monomers, e.g., a terpolymer. The more specific descriptions “ethylene acrylic acid copolymer”, “ethylene methacrylic acid copolymer”, and the like, also include copolymers of two or more monomers.

The term “partially grafted copolymer” refers to the product of a reaction between an acid copolymer and a grafting reagent, the extent of which reaction is limited by the equivalents of acid functionality of the acid copolymer.

Ethylene/acid copolymers, which are also referred to herein as “acid copolymers” are direct or graft copolymers of ethylene with at least one olefinically unsaturated organic mono- or di-acid such as acrylic or methacrylic acid, or maleic acid or fumaric acid, or an acid anhydride, wherein about 0.5 to 50 mole percent of the total polymeric material is derived from the acid or anhydride monomer(s). Ethylene/acid copolymers and methods for their preparation are well known in the art and are disclosed in, for example, U.S. Pat. Nos. 3,264,272; 3,404,134; 3,355,319; and 4,321,337.

The term “ionomers” as used herein refers to ethylene/acid copolymers whose acid moieties are at least partially neutralized to produce carboxylate anion moieties that are associated with a metal cation such as sodium, potassium, zinc, or the like.

The terms “finite amount” and “finite value”, as used herein, refer to an amount that is not equal to zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The flame retardant composition of the invention comprises a polymer blend consisting essentially of polyphenylene sulfide, a polymeric grafting agent, and an ethylene copolymer.

Polyphenylene sulfide (PPS) is well known in the art. See, e.g., U.S. Pat. No. 5,625,002. The PPS resins suitable for use in the invention have high melting points (melting onset near 265° C.) and are substantially linear polymers having relatively high molecular weight. Preferably, the PPS is also characterized by a significant quantity of reactive end groups such as —C₆H₄Cl, —C₆H₄S—Na⁺, or —C₆H₄SH. See Darryl R. Fahey and Jon F. Geibel, “Poly(Phenylene Sulfide) (Synthesis by p-Dichlorobenzene and Sodium Sulfide)” in Polymeric Materials Encyclopedia, ed. J. C. Salamone, vol. 8, p. 6510. To the extent that these end groups are present, they are expected to have a beneficial effect on the properties of the compositions of the invention, because the end groups allow for additional grafting between the polymeric grafting agent and the PPS phase.

Preferred PPS resins for use in the present invention are commercially available. One preferred PPS resin is Ryton™ PR34, available from the Chevron Phillips Chemical Company LP of The Woodlands, Tex.

The polymer blend component of the composition of the invention preferably contains about 40% to about 95% by weight PPS, more preferably about 55% to about 85% by weight, and still more preferably about 80% by weight, based on the total weight of the polymer blend component.

The polymer blend in the flame retardant composition of the invention also includes a polymeric grafting agent. Polymeric grafting agents suitable for use in the invention result from the copolymerization of ethylene with one or more monomers including primary reactive groups selected from unsaturated epoxides comprising 4 to 11 carbon atoms, such as glycidyl acrylate, glycidyl methacrylate (GMA), allyl glycidyl ether, vinyl glycidyl ether, and glycidyl itaconate; unsaturated isocyanates of 2 to 11 carbon atoms, such as vinyl isocyanate and isocyanato-ethyl methylacrylate; aziridine; silanes; or oxazoline. The polymeric grafting agent may also contain one or more secondary reactive moieties such as alkyl acrylate, alkyl methacrylate, carbon monoxide, sulfur dioxide and/or an alkyl vinyl ether, where the alkyl radical includes from 1 to 12 carbon atoms.

Preferably, the polymeric grafting agent is a copolymer of at least 50% by weight ethylene, 0.5% to 15% by weight of at least one primary reactive moiety selected from the group consisting of (i) an unsaturated epoxide of 4 to 11 carbon atoms; (ii) an unsaturated isocyanate of 2 to 11 carbon atoms; (iii) an alkoxy or alkyl silane wherein the alkyl group is from 1 to 12 carbon atoms; and (iv) an oxazoline; and 0 to 49% by weight of at least one secondary reactive moiety selected from alkyl acrylate, alkyl methacrylate, vinyl ether, carbon monoxide, and sulfur dioxide, wherein the alkyl and ether groups include 1 to 12 carbon atoms.

Preferred polymeric grafting agents for use in the compositions of the present invention include ethylene/glycidyl acrylate, ethylene/n-butyl acrylate/glycidyl acrylate, ethylene/methylacrylate/glycidyl acrylate, ethylene/glycidyl methacrylate (E/GMA), ethylene/n-butyl acrylate/glycidyl methacrylate (E/nBA/GMA or EnBAGMA) and ethylene/methylacrylate/glycidyl methacrylate copolymers. More preferred grafting agents for use in the compositions of the present invention are copolymers derived from ethylene/n-butyl acrylate/glycidyl methacrylate and ethylene/glycidyl methacrylate.

A particularly preferred polymeric grafting agent is a copolymer of at least 55% by weight ethylene, 1 to 10% by weight of an unsaturated epoxide of 4 to 11 carbon atoms, and 0 to 35% by weight of at least one alkyl acrylate, alkyl methacrylate, or mixtures thereof wherein the alkyl groups contain 1 to 8 carbon atoms. Preferred unsaturated epoxides are glycidyl methacrylate and glycidyl acrylate which are present in the copolymer at a level of 1 to 7% by weight. Preferably, ethylene content is greater than 60% by weight, and the third moiety is selected from methyl acrylate, iso-butyl acrylate, and n-butyl acrylate.

The polymer blend portion of the composition of the invention comprises about 3% to about 50% by weight of the polymeric grafting agent, preferably about 20% to about 40%, and more preferably about 30% to about 37% by weight, with a suggested optimum of about 33% by weight of the polymeric grafting agent, depending upon the nature and content of other components.

In the ethylene copolymers suitable for use in the polymer blend component of the present invention comprise, for every one hundred parts by weight ethylene copolymer, at least 50 parts by weight are derived from ethylene comonomer; from 1 to 35 parts by weight are derived from an acid containing unsaturated carboxylic acid or anhydride comonomer; and from 0 to 49 parts by weight are derived from a comonomer selected from the group consisting of alkyl acrylate, alkyl methacrylate, vinyl ether, carbon monoxide, and sulfur dioxide. In addition, the acid groups of the suitable ethylene copolymers may be unneutralized or up to 100% neutralized by a metal ion.

Preferred ethylene copolymers comprise at least 60% by weight of ethylene, 5 to 15% by weight of acrylic acid or methacrylic acid, and 0 to 25% by weight of at least one comonomer selected from methyl acrylate, iso-butyl acrylate, and n-butyl acrylate, and the acid groups are unneutralized or up to 70% neutralized, preferably from 30 to 70% neutralized, by at least one metal ion selected from lithium, potassium, sodium, zinc, magnesium, aluminum, and calcium.

Preferred ethylene copolymers include ethylene/acrylic acid, ethylene/methacrylic acid (E/MAA), ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/ethyl vinyl ether, ethylene/methacrylic acid/butyl vinyl ether, ethylene/acrylic acid/methyl acrylate, ethylene/methacrylic acid/ethyl acrylate, ethylene/methacrylic acid/methyl methacrylate, ethylene/acrylic acid/n-butyl methacrylate, ethylene/methacrylic acid/ethyl vinyl ether and ethylene/acrylic acid/butyl vinyl ether. The more preferred ethylene copolymers for use in the compositions of the present invention are ethylene/methacrylic acid, ethylene/acrylic acid copolymers, ethylene/methacrylic acid/n-butyl acrylate and ethylene/methacrylic acid/methylacrylate terpolymers.

Certain preferred ethylene copolymers for use in the present invention are commercially available from the E.I. du Pont de Nemours & Co. of Wilmington, Del., under the trademarks Nucrel® and Surlyn®.

The polymer blend component of the compositions of the invention comprises about 1% to about 20% by weight of the ethylene copolymer, preferably about 5% to about 15% by weight, more preferably about 7% by weight, based on the total weight of the polymer blend component.

The composition of the invention also includes at least about 8 weight percent and up to about 13 weight percent of brominated polystyrene and antimony oxide, based on the total weight of the flame retardant composition.

Suitable brominated polystyrenes (Br-PS) for use in the present invention include any member of the generic “brominated polystyrene” category designated by CAS No. 88497-57-3, which may include the products of bromination of pre-formed polystyrene as well as a range of polymers produced from brominated styrene monomers, such as, for example, poly-dibromostyrene (CAS No. 148993-99-1) and poly-tribromostyrene (CAS No. 57137-10-7). Polymers produced from reaction mixtures including tribromostyrene are preferred. Some preferred brominated polystyrenes for use in the present invention are available commercially, including, e.g., Pyrocheck™ 68PBC, which may be purchased from Albemarle Corp. of Richmond, Va.

Any grade of antimony oxide is suitable for use in the present invention, provided that its particle size is compatible with processing methods and conditions, and that its carrier, if any, is compatible with the polymeric components of the composition of the invention. Some preferred grades of antimony oxide for use in the present invention are available commercially, e.g., Endura® PE-80, available from Polymer Products Co. of Stockertown, Pa.

The weight of Br-PS and the weight of antimony oxide in the composition of the invention may be related by any finite ratio that is not equal to zero. That is, a finite amount of each of the Br-PS and antimony oxide must be present in the flame retardant composition. Preferably, the ratio of the weight of Br-PS to the weight of antimony oxide ranges from about 12 to 1 to about 1 to 12. More preferably, the ratio of the weight of Br-PS to the weight of antimony oxide ranges from about 6 to 1 to about 1 to 6. Still more preferably, the ratio of the weight of Br-PS to the weight of antimony oxide is about 10 to 3.

The flame retardant composition of the invention may optionally include fiberglass. Fiberglass advantageously increases the flex modulus of the compositions of the invention. A preferred fiberglass for use in the present invention is available under the tradename Chopvantage™ from PPG Industries of Pittsburgh, Pa.

The fiberglass may be present at any level up to about 45 weight percent of the total weight of the flame retardant composition. Preferably, the fiberglass is present at a level of up to about 0, 5, 10, 15, 20, 25, 30, 35, 40, or 45 weight percent, based on the total weight of the flame retardant composition.

The compositions of the present invention may also include such other ingredients as are customarily used in the compounding of thermoplastics, provided that such other ingredients do not eliminate the flame retardant features of the composition of the invention by virtue of their amount or properties. Examples of other ingredients suitable for use in the present invention include, without limitation, reinforcing fillers such as carbon black, graphite fibers, glass spheres, silica, titanium dioxide, other pigments, clay, mica, and other mineral fillers; plasticizers; lubricants; additional flame retardants; metal deactivators; antioxidants; ultraviolet stabilizers; heat stabilizers; processing aids; adhesives; and tackifiers. One stabilizer that is preferred for use in the present invention is pentaerythritol tetrakis(3-(3,5-di-tert-butyl-4-hydroxyphenyl) propionate, which is available commercially from Ciba Specialty Chemicals, Inc., of Tarrytown, N.Y., as Irganox™ 1010.

Certain of the compositions of the invention are particularly well suited for high temperature applications requiring chemical resistance, flame resistance, and flexibility. Specifically, when the weight ratio of the polymeric grafting agent to the ethylene copolymer ranges from about 3:1 to about 20:1, the resulting polymer alloy demonstrates superior flexural modulus and tensile strength, as well as enhanced elongation at break, and improved retention of elongation at break upon aging.

More particularly, the molar ratio of the first reactive moiety of the polymeric grafting agent to acid moiety of the ethylene copolymer may provide a more accurate indication of the preferred compositions. The molar ratio is calculated simply as the number of moles of the first reactive moiety in the polymeric grafting agent, e.g., GMA, divided by the number of moles of acid moiety, e.g., MAA, in the ethylene copolymer. Preferably, the molar ratio of the first reactive moieties to the acid moieties ranges from about 1.0 to about 5.5, more preferably about 1.0 to about 5.25, still more preferably about 1.7 to about 4, and still more preferably about 1.7 to about 1.9.

As-molded elongation at break (ELO) levels about 150 and higher are critical for wire and cable applications. Compositions, as described herein, having a weight ratio of polymeric grafting agent to ethylene copolymer in the range of about 3:1 to about 20:1, or preferably having a molar ratio of the first reactive moiety of the polymeric grafting agent to acid moiety of the ethylene copolymer in the range of about 1.0 to about 5.5, also demonstrate excellent flame retardancy as demonstrated by the LOI, volume swell and electrical properties. The compositions of the invention are thus particularly well suited to wire and cable applications, though other applications requiring a similar balance of properties are contemplated.

The preferred weight ratio of polymeric grafting agent to ethylene copolymer in the polymer blend of the wire and cable coating compositions ranges from about 4:1 to about 18:1, and more preferably about 5:1 to about 15:1. Moreover, the polymer blend preferably contains at least about 30 weight percent, and more preferably at least about 40 weight percent of of polymeric grafting agent and ethylene copolymer combined.

Some particularly preferred polymer blends comprise 60% by weight PPS; 33.3% by weight polymeric grafting agent, e.g. EnBAGMA comprising 5.25 wt % GMA; and 6.7% by weight ethylene copolymer comprising 9.0 wt. % MAA, optionally up to 100% neutralized. In these blends, the weight ratio of polymeric grafting agent to ethylene copolymer is about 5:1, and/or the molar ratio of the first reactive moiety of the polymeric grafting agent to acid moiety of the ethylene copolymer is about 1.8.

To compound the flame retardant compositions of the invention, the three components of the polymer blend are melt blended with each other under high shear. The components may first be combined with one another in a “salt and pepper” blend, i.e., a pellet blend of each of the ingredients, or they may be combined with one another via simultaneous or separate metering of the various components, or they may be divided and blended in one or more passes into one or more sections of mixing equipment such as an extruder, Banbury, Buss Kneader, Farrell continuous mixer, or other mixing equipment. For example, an extruder with two or more feed zones into which one or more of the ingredients may be added sequentially can be used.

The antimony oxide, Br-PS, and fiberglass, if present, may be added to the pellet blend, or they may be combined with the other components of the composition via simultaneous or separate metering during the melt blending, or they may be divided and blended in one or more passes into one or more sections of mixing equipment. Alternatively, they may be added to the polymer blend after it has been compounded.

The order of addition of the components during compounding is not believed to have any effect on the flame retardant properties of the composition of the invention. High shear conditions during compounding, however, leads to optimal dispersion of the components, and optimal dispersion, in turn, ensures that the grafting reaction is carried out as fully and uniformly as possible. In addition, sufficient mixing is essential to achieve the preferred morphology, in which the thermoplastic polymer blend is the continuous phase.

Also provided by the present invention are articles comprising the flame retardant composition of the invention. Such articles may be made according to methods that are well known in the art. For example, after mixing the components of the flame retardant composition in an extruder, the flame retardant composition is a fluid that may be shaped by injection molding, casting, melt extrusion, flat die extrusion, blown film extrusion, melt shaping or any other technique that will produce the desired shape. Injection molding is a preferred method of forming articles according to the invention. The flame retardant composition may also be formed into fibers and filaments by methods well known in the art, such as spinning, extrusion, cold drawing, and the like. See, e.g., U.S. Pat. No. 2,418,492, issued to Alfthan et al. When solidified, the flame retardant composition may be shaped by grinding, milling, carving, and the like.

The flame retardant composition may be used alone, or it may be used in combination with other materials to form flame resistant articles. Replacing even a portion of flammable material in a conventional article with the flame retardant composition of the invention is expected to enhance the flame resistance of the article.

When the flame retardant composition of the invention is used in combination with other materials, the combination may be a uniform mixture, such as a polymer blend, or a non-uniform mixture, such as a dispersion. For example, the flame retardant composition may be formed into particles and incorporated, as particles that keep their integrity, into another polymeric material. A combination according to the invention may also be formed by permanently or reversibly fastening two or more objects, at least one of which comprises the flame retardant composition of the invention.

Preferably, the flame retardant compositions of the present invention are used to make flame retardant articles for use in or near combustion engines, such as automotive engines. It is to be understood, however, that the articles and methods described herein are considered to be within the scope of the invention, whether they are used in automotive applications or in a different context. Examples of suitable automotive parts whose flame resistance may be increased by at least partial fabrication from a flame retardant composition of the invention include, without limitation, tubes and fittings, insulation, floor mats, fan shrouds, electrical connectors, motor housings, and the like.

The following examples are provided to describe the invention in further detail. These examples, which set forth a preferred mode presently contemplated for carrying out the invention, are intended to illustrate and not to limit the invention.

### EXAMPLES

The components set forth in Table 1, below, were compounded in a 30 mm twin screw extruder at 150 RPM. The total feed rate was 12 lb/hr, the temperature in all zones was held at 265° C., and the die temperature was 270° C. The Br-PS (Pyrocheck™ 68PBC) and antimony trioxide concentrate (Endura™ PE-80) were added to the pellet feed with the PPS, the ethylene copolymer (Surlyn® 9320), and the stabilizer (Irganox™ 1010). The polymeric grafting agent (EnBAGMA-5, a terpolymer of 71.75 wt % ethylene, 23 wt % n-butyl acrylate, and 5.25 wt % glycidyl methacrylate) and the glass fibers, when present, were added at barrel 6 through a side-stuffer.

The extruded samples were injection molded to form “Type V” tensile bars. Samples were equilibrated at 23° C. and 50% RH for 48 hours before testing according to ASTM D638 and UL94 test protocols. Samples A, B, and C were tested using a crosshead speed of 2 inch/min, and Samples D through H were tested using a crosshead speed of 0.2 inch/min. Further information regarding Standard Test Method D638 is available from ASTM International of West Conshohocken, Pa. Further information regarding the UL94 Standard is available from Underwriters Laboratories, Inc., of Northbrook, Ill.

The results of the ASTM D638 and UL-94 tests of each of the samples are set forth in Tables 2 and 3, respectively, below.

TABLE 1
Compositions

| | Comparative | B | C | D | E | Comparative | G | H |
|---|---|---|---|---|---|---|---|---|
| Sample/Material | A (wt %) | (wt %) | (wt %) | (wt %) | (wt %) | F (wt %) | (wt %) | (wt %) |
| Ryton ™ PR34 | 65.0 | 59.8 | 56.5 | 43.4 | 38.9 | 42.1 | 33.6 | 36.9 |
| Poly(phenylene | | | | | | | | |
| sulfide) | | | | | | | | |
| E/nBA/GMA-5 | 28.7 | 26.4 | 25.0 | 19.2 | 17.2 | 18.6 | 14.9 | 16.3 |
| Surlyn ® 9320 | 5.8 | 5.3 | 5.0 | 3.9 | 3.5 | 3.8 | 3.0 | 3.3 |
| Ethylene | | | | | | | | |
| copolymer | | | | | | | | |
| Pyrocheck ™ | 0.0 | 6.2 | 10.0 | 10.0 | 10.0 | 0.0 | 10.0 | 6.2 |
| Brominated | | | | | | | | |
| polystyrene | | | | | | | | |
| Endura ™ PE-80 | 0.0 | 1.8 | 3.0 | 3.0 | 3.0 | 0.0 | 3.0 | 1.8 |
| (Sb₂O₃ content, | | (1.44) | (2.4) | (2.4) | (2.4) | | (2.4) | (1.44) |
| 80 wt % of PE-80) | | | | | | | | |
| PPG | 0.0 | 0.0 | 0.0 | 20.0 | 27.0 | 35.0 | 35.0 | 35.0 |
| Chopvantage ™ | | | | | | | | |
| 3563 Glass | | | | | | | | |
| Fibers | | | | | | | | |
| Irganox ™ 1010 | 0.5 | 0.5 | 0.5 | 0.5 | 0.5 | 0.5 | 0.5 | 0.5 |
| Stabilizer | | | | | | | | |

TABLE 2
Tensile Properties

| | | | | | | | | | | | Mean | |
|---|---|---|---|---|---|---|---|---|---|---|---|---|
| | Sample 1 | | Sample 2 | | Sample 3 | | Sample 4 | | Sample 5 | | elon- | Mean |
| Exam- | Elongation | Young's | Elongation | Young's | Elongation | Young's | Elongation | Young's | Elongation | Young's | gation | Young's |
| ple | at break | Modulus | at break | Modulus | at break | modulus | at break | modulus | at break | modulus | at break | modulus |
| No. | % | ksi | % | ksi | % | ksi | % | ksi | % | ksi | % | ksi |
| 80A | 48.5 | 99.292 | 50.5 | 112.485 | 26.4 | 112.758 | 43.7 | 110.535 | 40.4 | 97.361 | 41.9 | 106.486 |
| 80B | 57.1 | 111.85 | 51.3 | 119.741 | 58.7 | 113.452 | 58.6 | 104.849 | 60.4 | 115.770 | 57.2 | 113.131 |
| 80C | 15.4 | 126.730 | 23.8 | 121.432 | 32.2 | 123.410 | 20.4 | 126.176 | 12.1 | 122.26 | 20.8 | 124.001 |
| 80D | 4.3 | 388.04 | 4.5 | 381.590 | 4.5 | 370.170 | 4.4 | 358.342 | 4.6 | 391.55 | 4.5 | 377.938 |
| 80E | 4.1 | 414.93 | 4.2 | 458.499 | 4.2 | 488.315 | 4.2 | 466.271 | — | — | 4.2 | 457.003 |
| 80F | 3.1 | 588.87 | 4.2 | 587.336 | 4.2 | 529.983 | 4.1 | 520.169 | 4.2 | 568.19 | 3.9 | 558.910 |
| 80G | 4.0 | 578.32 | 4.0 | 585.180 | 4.0 | 583.796 | 4.2 | 598.300 | 4.1 | 581.83 | 4.1 | 585.484 |
| 80H | 4.2 | 562.86 | 4.4 | 563.092 | 4.2 | 558.412 | 4.3 | 550.816 | 4.2 | 555.38 | 4.3 | 558.112 |

TABLE 3
UL94 Test Method Data (in seconds)

| Sample | 1/16″ | ⅛″ | Sample | 1/16″ | ⅛″ | Sample | 1/16″ | ⅛″ | Sample | 1/16″ | ⅛″ |
|---|---|---|---|---|---|---|---|---|---|---|---|
| 80A | Thickness | Thickness | 80B | Thickness | Thickness | 80C | Thickness | Thickness | 80D | Thickness | Thickness |
| Test | 1st, 2nd | 1st, 2nd | Test | 1st, 2nd | 1st, 2nd | Test | 1st, 2nd | 1st, 2nd | Test | 1st, 2nd | 1st, 2nd |
| #1 | >10 | >10 | #1 | >10 | 2, >10 | #1 | 2, 1 | 1, 1 | #1 | >10 | 1, 6 |
| #2 | >10 | >10 | #2 | >10 | >10 | #2 | 2, 1 | 1, 1 | #2 | >10 | 1, 2 |
| #3 | >10 | >10 | #3 | >10 | >10 | #3 | 3, 4 | 1, 1 | #3 | >10 | 1, 9 |
| #4 | >10 | >10 | #4 | >10 | 2, >10 | #4 | 1, 1 | 1, 1 | #4 | >10 | 1, 8 |
| #5 | >10 | >10 | #5 | >10 | 2, >10 | #5 | 2, 2 | 1, 1 | #5 | >10 | 2, 9 |
| Sample | 1/16″ | ⅛″ | Sample | 1/16″ | ⅛″ | Sample | 1/16″ | ⅛″ | Sample | 1/16″ | ⅛″ |
| 80E | Thickness | Thickness | 80F | Thickness | Thickness | 80G | Thickness | Thickness | 80H | Thickness | Thickness |
| Test | 1st, 2nd | 1st, 2nd | Test | 1st, 2nd | 1st, 2nd | Test | 1st, 2nd | 1st, 2nd | Test | 1st, 2nd | 1st, 2nd |
| #1 | 1, 9 | 1, 7 | #1 | >10 | 2, >10 | #1 | 1, 1 | 1, 1 | #1 | >10 | >10 |
| #2 | 1, >10 | 1, 3 | #2 | >10 | >10 | #2 | 1, 1 | 1, 1 | #2 | >10 | >10 |
| #3 | 1, >10 | 1, 3 | #3 | >10 | >10 | #3 | 1, 2 | 1, 1 | #3 | >10 | >10 |
| #4 | 2, >10 | 1, 4 | #4 | >10 | 2, >10 | #4 | 1, 1 | 1, 2 | #4 | >10 | >10 |
| #5 | 4, 6 | 1, 3 | #5 | >10 | 2, >10 | #5 | 1, 2 | 1, 1 | #5 | >10 | >10 |

The data in Table 2 indicate that the addition of glass fibers to the flame retardant composition of the invention reduces the elongation at break by approximately an order of magnitude, and increases the Young's modulus by a factor of 3 to 6. Moreover, comparison of the elongation at break measurements of the examples of the invention to the measurements of comparative examples A and F demonstrates that the addition of the Br-PS and antimony oxide to the PPS blend surprisingly has little effect on the elongation at break for both glass-filled and neat resins.

The data obtained from the UL94 flame test (in seconds) are set forth in Table 3. These data show that the flaming combustion time of comparative samples A and F is typically greater than 10 seconds. Thus, the comparative samples fail to attain a V-O flame resistance rating. In contrast, the data from samples C and G, which contain greater than 8 weight percent of Br-PS and antimony oxide, both achieve a V-O rating with combustion times in the 1 to 2 second range. In addition, samples C and G both have an elongation at break that is greater than 3%.

Having thus described and exemplified the invention with a certain degree of particularity, it should be appreciated that the following claims are not to be so limited but are to be afforded a scope commensurate with the wording of each element of the claim and equivalents thereof.

What is claimed is:

1. A flame retardant composition comprising:
(A) from about 52 to 72 weight percent of a polymer blend consisting essentially of:
(a) from 40% to 95% by weight polyphenylene sulfide;
(b) from 3% to 50% by weight of a polymeric grafting agent, said grafting agent comprising a copolymer wherein for every one hundred parts by weight copolymer (I) at least 50 parts by weight are derived from ethylene comonomer; (ii) from 0.5 to 15 parts by weight are derived from one or more reactive comonomer selected from the group consisting of an unsaturated epoxide of 4 to 11 carbon atoms; an unsaturated isocyanate of 2 to 11 carbon atoms; an unsaturated alkoxy silane and unsaturated alkyl silane, wherein the alkoxy and the alkyl group is from 1 to 12 carbon atoms; and an unsaturated oxazoline; and (iii) from 0 to 49 parts by weight are derived from an optional third comonomer selected from the group consisting of an alkyl acrylate, alkyl methacrylate, vinyl ether, carbon monoxide, and sulfur dioxide, where the alkyl and ether groups are of 1 to 12 carbon atoms; and
(c) from 1% to 20% by weight of an ethylene copolymer, wherein for every one hundred parts by weight ethylene copolymer (i) at least 50 parts by weight are derived from ethylene comonomer, (ii) from 1 to 35 parts by weight are derived from an acid-containing unsaturated carboxylic acid or anhydride comonomer, and (iii) from 0 to 49 parts by weight are derived from a comonomer selected from the group consisting of alkyl acrylate, alkyl methacrylate, vinyl ether, carbon monoxide, and sulfur dioxide, and further wherein the acid groups are neutralized from 0 to 100% by a metal ion,
(B) at least 8 up to about 13 weight percent of a mixture of brominated polystyrene and antimony oxide; and, optionally,
(C) up to about 45 weight percent fiberglass.

2. The flame retardant composition of claim 1 wherein the molar ratio of said reactive comonomer of (b) to said acid-containing comonomer of (c) is from 1.7 to 4; said polymeric grafting agent (b) is a terpolymer of ethylene/n-butyl acrylate/glycidyl methacrylate; and said ethylene copolymer (c) is an ionomer.

3. The flame retardant composition of claim 1 wherein said mixture of brominated polystyrene and antimony oxide comprises about 10% by weight brominated polystyrene and about 3% antimony oxide and said fiberglass is present at about 20% to about 35% by weight, based on the total weight of the flexible, fiber-reinforced, flame retardant wire and cable coating composition.

4. The flame retardant composition of claim 2 wherein said mixture of brominated polystyrene and antimony oxide comprises about 10% by weight brominated polystyrene and about 3% antimony oxide and said fiberglass is present at about 20% to about 35% by weight, based on the total weight of the flexible, fiber-reinforced, flame retardant wire and cable coating composition.

5. An article comprising the flame retardant composition of claim 1.

6. An article comprising the flame retardant composition of claim 2.

7. An article comprising the flame retardant composition of claim 3.

8. An article comprising the flame retardant composition of claim 4.

9. An article according to claim 5, said article being formed by melt shaping.

10. An article according to claim 5, said article being formed by injection molding.

11. An article according to claim 5, said article being formed by extrusion.

12. An article according to claim 5, said article being formed by blow molding.

13. A flame retardant composition comprising:
(A) from about 52 to 72 weight percent of a polymer blend consisting essentially of:
(a) from 40% to 95% by weight polyphenylene sulfide;
(b) from 3% to 50% by weight of a polymeric grafting agent, said grafting agent comprising a copolymer wherein for every one hundred parts by weight copolymer (I) at least 50 parts by weight are derived from ethylene comonomer; (ii) from 0.5 to 15 parts by weight are derived from one or more reactive comonomer selected from the group consisting of an unsaturated epoxide of 4 to 11 carbon atoms; an unsaturated isocyanate of 2 to 11 carbon atoms; an unsaturated alkoxy silane and unsaturated alkyl silane, wherein the alkoxy and the alkyl group is from 1 to 12 carbon atoms; and an unsaturated oxazoline; and (iii) from 0 to 49 parts by weight are derived from an optional third comonomer selected from the group consisting of an alkyl acrylate, alkyl methacrylate, vinyl ether, carbon monoxide, and sulfur dioxide, where the alkyl and ether groups are of 1 to 12 carbon atoms; and
(c) from 1% to 20% by weight of an ethylene copolymer, wherein for every one hundred parts by weight ethylene copolymer (i) at least 50 parts by weight are derived from ethylene comonomer, (ii) from 1 to 35 parts by weight are derived from an acid-containing unsaturated carboxylic acid or anhydride comonomer, and (iii) from 0 to 49 parts by weight are derived from a comonomer selected from the group consisting of alkyl acrylate, alkyl methacrylate, vinyl ether, carbon monoxide, and sulfur dioxide, and further wherein the acid groups are neutralized from 0 to 100% by a metal ion,
(B) at least 8 up to about 13 weight percent of a mixture of brominated polystyrene and antimony oxide; and, optionally,
(C) up to about 45 weight percent fiberglass, wherein said flame retardant composition is self extinguishing in 10 seconds or less according to UL-94 and exhibits elongation at break in excess of 3.0% according to ASTM D638.

14. The flame retardant composition of claim 13 wherein the molar ratio of said reactive comonomer of (b) to said acid-containing comonomer of (c) is from 1.7 to 4; said polymeric grafting agent (b) is a terpolymer of ethylene/n-butyl acrylate/glycidyl methacrylate; and said ethylene copolymer (c) is an ionomer.

15. The flame retardant composition of claim 13 wherein said mixture of brominated polystyrene and antimony oxide comprises about 10% by weight brominated polystyrene and about 3% antimony oxide and said fiberglass is present at about 20% to about 35% by weight, based on the total weight of the flexible, fiber-reinforced, flame retardant wire and cable coating composition.

16. The flame retardant composition of claim 14 wherein said mixture of brominated polystyrene and antimony oxide comprises about 10% by weight brominated polystyrene and about 3% antimony oxide and said fiberglass is present at about 20% to about 35% by weight, based on the total weight of the flexible, fiber-reinforced, flame retardant wire and cable coating composition.

17. An article comprising the flame retardant composition of claim 13.

18. An article comprising the flame retardant composition of claim 14.

19. An article comprising the flame retardant composition of claim 15.

20. An article comprising the flame retardant composition of claim 16.

21. An article according to claim 17, said article being formed by melt shaping.

22. An article according to claim 17, said article being formed by injection molding.

23. An article according to claim 17, said article being formed by extrusion.

24. An article according to claim 17, said article being formed by blow molding.
